(19) United States
(12) Patent Application Publication
(10) Pub. No.: US 2006/0270800 A1
(43) Pub. Date: Nov. 30, 2006

(54) Molding compound

(75) Inventors: Domonique Teyssie, Le Pecq (FR); Cedric Vancaeyzeele, Vernauillet (FR); Judith Laskar, La Garenne Colombes (FR); Odile Fichet, Poissy (FR); Sylvie Boileau, Paris (FR); Richard J. Blackborow, Strasbourg (FR); Hans Peter Rath, Gruenstadt (DE); Arno Lange, Bad Duerkheim (DE); Gabriele Lang, Mannheim (DE); Helmut Mach, Heidelberg (DE); Margit Hiller, Karlstadt (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 10/568,410

(22) PCT Filed: Aug. 19, 2004
(86) PCT No.: PCT/EP04/09312

§ 371 Date: Feb. 14, 2006

(30) Foreign Application Priority Data
Aug. 20, 2003 (DE) 10338245.3

(51) Int. Cl. C08F 8/00

(52) U.S. Cl. 525/191

(57) ABSTRACT

A molding composition is described and comprises a mixture of interpenetrating polymers. A first phase comprises a crosslinked isobutene polymer, and a second phase encompasses a reinforcing polymer comprising (meth)acrylic and/or vinylaromatic units. The first phase is the reaction product of an isobutene polymer having an average of at least 1.4 functional groups in the molecule and of a crosslinking agent having an average of at least two functional groups in the molecule, the functionality of these being complementary to that of the functional groups of the isobutene polymer. The molding composition is particularly suitable for the roofing of buildings, or as impact-modified polystyrene or polymethyl methacrylate.

The invention relates to a molding composition which comprises a mixture of interpenetrating polymers with a first phase of a crosslinked polyalkylene polymer and with a second phase of a reinforcing polymer comprising (meth)acrylate units and/or vinylaromatic units.

Polyisobutene rubbers feature particular properties, such as low permeability to gases and moisture, high elasticity, and low-temperature flexibility down to very low temperatures. Polyisobutenes have excellent resistance to weathering and UV. However, certain properties of polyisobutene rubbers, such as resistance to solvents or mechanical strength, are not satisfactory for most applications.

However, thermoplastics, such as polystyrene or polymethyl methacrylate, have high tensile strengths. It is desirable to combine the properties of polyisobutene rubbers and polystyrenes.

Paul D. R. and Barlow J. W., J. Macromol. Sci., Rev. Macromol. Chem., 18, 109 (1980) and Krause S. in “Polymer Blends” 1, 66, Paul D. R. and Newman S. ed., Academic Press New York (1978) has disclosed that polyalkylene polymers and atactic polystyrene are completely incompatible. Physical mixtures of these polymers are heterogeneous and exhibit the two glass transition temperatures of the pure components, because of lack of miscibility.

Attempts have been made to mix the polymers at the molecular level and thus to obtain what may be called interpenetrating networks, by swelling a crosslinked polyalkylene polymer with styrene and then polymerizing the styrene in situ. However, the degree of swelling achievable is limited, and the contents of polystyrene which can be introduced into the network in this way are not substantially higher than 10%. In addition, the resultant modification of properties is unstable and disappears on exposure to thermal stress because of phenomena associated with demixing.

U.S. Pat. No. 6,005,051 describes multicomponent polymer networks comprising polyisobutene. The material here is a single network with a number of chemically different, covalently bonded sequences.

It is an object of the invention to provide a network composed of a polyalkylene in a reinforcing polymer which comprises (meth)acrylate units and/or vinylaromatic units, where the relative amounts of the two phases can be varied within a wide range, and the mutual interpenetration of the two phases is satisfactory, and no phenomena associated with demixing occur during formation of the network.

The invention achieves the object via a molding composition comprising a mixture of interpenetrating polymers with a first phase of a crosslinked isobutene polymer and with a second phase of a reinforcing polymer which comprises (meth)acrylic and/or vinylaromatic units, where the first phase comprises the reaction product of an isobutene polymer with an average of at least 1.4 functional groups in the molecule and of a crosslinking agent with an average of at least two functional groups in the molecule, the functionality of these being complementary to that of the functional groups of the isobutene polymer. The molding composition may comprise further interpenetrating polymers, such as polymeric compatibilizers.

An example of a procedure for preparing an inventive molding composition consists in

(i) the monomers which form the structure of the reinforcing polymer being polymerized by a free-radical route in the presence of the first phase, or

(ii) the isobutene polymer, the crosslinking agent, and the monomers which form the structure of the reinforcing polymer being mixed, and the reaction between the isobutene polymer and the crosslinking agent and the free-radical polymerization of the monomers being initiated simultaneously or in succession.

The ratio by weight of the first to the second phase in the inventive molding composition is generally from 5:95 to 95:5, preferably from 5:95 to 80:20, in particular from 30:70 to 70:30. In the case of inventive molding compositions with high content of the isobutene polymer phase (e.g. with a ratio by weight of the first to the second phase of from 60:40 to 80:20) the barrier properties of the polyisobutene are substantially retained; the content of the reinforcing polymer supplies the necessary tensile strain at break. Molding compositions with high contents of the reinforcing polymer (e.g. with a ratio by weight of the first phase to the second phase of from 5:95 to 25:75) are stiff and have low extensibility; here, the isobutene polymer phase serves for impact modification. In the use of impact modification, the isobutene polymer phase advantageously has a low crosslinking density. One preferred such embodiment of the invention is provided by impact-modified polystyrenes of polymethyl methacrylates.

The isobutene polymer comprises (prior to its crosslinking) at least 80% by weight, in particular at least 90% by weight, and particularly preferably at least 95% by weight, of isobutene units. Besides isobutene units, the isobutene polymer may also comprise units of olefinically unsaturated monomers which are copolymerizable with isobutene under the conditions of cationic polymerization. The comonomers may have random distribution in the polymer or have been arranged in the form of blocks.

Copolymerizable monomers which may be used are especially vinylaromatics, such as styrene, C₁-C₄-alkylstyrenes, such as α-methylstyrene, 3- and 4-methylstyrene, or 4-tert-butylstyrene, and also isoolefins having from 5 to 10 carbon atoms, e.g. 2-methyl-1-butene, 2-methyl-1-pentene, 2-methyl-1-hexene, 2-ethyl-1-pentene, 2-ethyl-1-hexene and 2-propyl-1-heptene.

The isobutene polymer prior to the crosslinking process preferably has a number-average molecular weight of from 500 to 50 000, in particular from 1000 to 20 000, particularly preferably from 2000 to 10 000.

The isobutene polymer has functional groups which can react with groups having complementary functionality on the crosslinking agent, to form covalent bonds. Although the functional groups of the isobutene polymer may have distribution over the length of the main polymer chain and may, by way of example, have been arranged in the main chain or in side chains of the polymer, for obtaining good elastic properties it is preferable for the functional groups of the isobutene polymer to have been arranged exclusively at the ends of the isobutene polymer molecule.

The person skilled in the art is aware of various combinations of groups having complementary functionality which can react with one another to form covalent bonds. By way of example, the functional groups of the isobutene polymer and of the crosslinking agent have been selected in pairs from isocyanate-reactive groups/isocyanate groups or olefinically unsaturated groups/hydrosilyl groups. Among the isocyanate-reactive groups are hydroxy groups, mercapto groups, amino groups, and carboxy groups, preference being given among these to hydroxy groups. In preferred embodiments of the inventive molding composition, the first phase therefore comprises the reaction product of (i) an isobutene polymer having olefinically unsaturated groups and of a crosslinking agent having hydrosilyl groups, or of (ii) an isobutene polymer having hydroxy groups and of a crosslinking agent having isocyanate groups.

Preferred embodiments will now be used to provide further illustration of the isobutene polymer, suitable crosslinking agents, and also the reinforcing polymer.

Isobutene Polymer

Terminally unsaturated polyisobutenes are advantageous starting materials for polyisobutenes having other terminal functional groups, such as hydroxy groups, because the olefinically unsaturated groups can easily be converted into other functional groups, such as hydroxy groups.

Examples of the olefinically unsaturated group are aliphatic unsaturated groups having from 2 to 6 carbon atoms, e.g. vinyl, allyl, methylvinyl, methallyl, propenyl, 2-methylpropenyl, butenyl, pentenyl, hexenyl; or cyclic unsaturated hydrocarbon radicals, such as cyclopropenyl, cyclobutenyl, cyclopentenyl and cylohexenyl. Preference is given to isobutene polymers having terminal allyl, methallyl, 2-methylpropenyl, or cyclopentenyl groups.

Suitable isobutene polymers may be prepared by processes described in U.S. Pat. No. 4,946,889, U.S. Pat. No. 4,327,201, U.S. Pat. No. 5,169,914, EP-A-206 756, EP-A-265 053, and also comprehensively described in J. P. Kennedy, B. Ivan, “Designed Polymers by Carbocationic Macromolecular Engineering”, Oxford University Press, New York, 1991. The isobutene polymers are prepared via living cationic polymerization of isobutene. The initiator system used generally comprises a Lewis acid and an “initiator”, i.e. an organic compound with a leaving group capable of easy substitution, which with the Lewis acid forms a carbocation or a cationogenic complex. The initiator is generally a tertiary halide, a tertiary ester or ether, or a compound having an allyl-positioned halogen atom, or an allyl-positioned alkoxy or acyloxy group. The carbocation or the cationogenic complex adds successive isobutene molecules to the cationic center, thus forming a growing polymer chain terminated by a carbocation or the leaving group of the initiator. The initiator may be mono- or polyfunctional, and in the latter case there is more than one direction of growth of polymer chains. The corresponding terms used for the initiator are inifer, binifer, trinifer, etc.

Isobutene polymers having a terminal double bond can be obtained in various ways. The starting materials may comprise olefinically unsaturated inifer molecules. To obtain polyisobutene molecules having more than one terminal double bond per molecule, an olefinic double bond may likewise be introduced in the distal chain end, or two or more living polymer chains may be coupled. Both possibilities are further illustrated below.

As an alternative, the starting materials comprise initiator molecules without any olefinic double bond, and the distal chain ends are terminated with formation of an ethylenically unsaturated group, e.g. by reacting the reactive chain end with a terminating reagent which adds an ethylenically unsaturated group to the chain ends, or by treating the reactive chain ends in a manner suitable to convert the reactive chain ends into groups of this type.

Suitable initiators without any olefinic double bond may be represented by the formula AYₙ, where A is an n-valent aromatic radical having from one to four non-anellated benzene rings, e.g. benzene, biphenyl, or terphenyl, or anellated benzene rings, e.g. naphthalene, anthracene, phenanthrene, or pyrene, or is an n-valent linear or branched aliphatic radical having from 3 to 20 carbon atoms. Y is C(R^{a})(R^{b})X, where R^{a} and R^{b} independently of one another are hydrogen, C₁-C₄-alkyl, in particular methyl, or phenyl, and X is halogen, C₁-C₆-alkoxy or C₁-C₆-acyloxy, with the proviso that R^{a} is phenyl if A is an aliphatic radical. n is whole number from 2 to 4, in particular 2 or 3. Suitable examples are p-dicumyl chloride, m-dicumyl chloride, or 1,3,5-tricumyl chloride.

An example of inifer having an olefinic double bond is a compound of the formula I 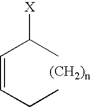
where
X is halogen, C₁-C₆-alkoxy, or C₁-C₆-acyloxy, and
n is 1, 2, or 3.

A particularly suitable compound of the formula I is 3-chlorocyclopentene.

The Lewis acid used may comprise covalent metal halides and semi-metal halides which are electron-pair acceptors. They are generally selected from halogen compounds of titanium, of tin, of aluminum, of vanadium, or of iron, or else from halides of boron. Particularly preferred Lewis acids are titanium tetrachloride, ethylaluminum dichloride, and boron trichloride, and for molecular weights above 5000 in particular titanium tetrachloride.

A proven successful method carries out the polymerization in the presence of an electron donor. Preferred donors are pyridine and sterically hindered pyridine derivatives, and also in particular organosilicon compounds. The polymerization is usually carried out in a solvent or solvent mixture, e.g. aliphatic hydrocarbons, aromatic hydrocarbons, or else halogenated hydrocarbons. Mixtures of aliphatic, cycloaliphatic, or aromatic hydrocarbons with halogenated hydrocarbons have proven particularly successful, e.g. dichloromethane/n-hexane, dichloromethane/methylcyclohexane, dichloromethane/toluene, chloromethane/n-hexane, and the like.

To introduce an olefinic double bond at the distal chain end, the reactive chain end is reacted with a terminating reagent which adds an olefinically unsaturated group to the chain end, or the reactive chain end is treated in a suitable manner to convert it into a group of this type.

In the simplest embodiment, the chain end is subjected to a dehydrohalogenation reaction, e.g. via thermal treatment, for example via heating to a temperature of from 70 to 200° C., or via treatment with a base. Examples of suitable bases are alkali metal alkoxides, such as sodium methanolate, sodium ethanolate, and sodium tert-butanolate, basic aluminum oxide, alkali metal hydroxides, such as sodium hydroxide, and tertiary amines, such as pyridine or tributylamine, cf. Kennedy et al., Polymer Bulletin 1985, 13, 435-439. Sodium ethanolate is preferably used.

As an alternative, the chain end is terminated via addition of a trialkylallylsilane compound, e.g. trimethylallylsilane. The use of the allylsilanes leads to termination of the polymerization with introduction of an allyl radical at the end of the polymer chain, c.f. EP 264 214.

In another embodiment, the reactive chain end is reacted with a conjugated diene, such as butadiene (cf. DE-A 40 25 961) or with an unconjugated diene, such as 1,9-decadiene, or with an alkenyloxystyrene, such as p-hexenyloxystyrene (cf. JP-A4-288309).

In another embodiment, two or more living polymer chains are coupled via addition of a coupling agent. “Coupling” means the formation of chemical bonds between the reactive chain ends so that two or more polymer chains are bonded to give one molecule. The molecules obtained via coupling are symmetrical telechelic or star-shaped molecules having groups of the initiator, e.g. cyclopentenyl groups, at the ends of the molecules or at the ends of the branches of the star-shaped molecule.

By way of example, suitable coupling agents have at least two electrofugic leaving groups arranged in the allyl position with respect to identical or different double bonds, e.g. trialkylsilyl groups, thus permitting the cationic center of a reactive chain end to undergo a concerted addition reaction with elimination of the leaving group and double-bond shift. Other coupling agents have at least one conjugated system with which the cationic center of a reactive chain end can undergo an electrophilic addition reaction with formation of a stabilized cation. Elimination of a leaving group, e.g. of a proton, then produces a stable σ-bond to the polymer chain, forming the conjugated system again. Inert spacers may connect a number of these conjugated systems to one another.

Among the suitable coupling agents are:
(i) compounds which have at least two 5-membered heterocycles having a heteroatom selected from oxygen, sulfur, and nitrogen, e.g. organic compounds which have at least two furan rings, for example 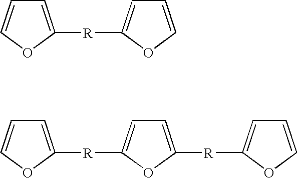
where R is C₁-C₁₀-alkylene, preferably methylene, or 2,2-propanediyl;
(ii) compounds having at least two trialkylsilyl groups in the allyl position, e.g. 1,1-bis(trialkylsilylmethyl)ethylenes, such as 1,1-bis(trimethylsilylmethyl)ethylene, bis[(trialkylsilyl)propenyl]benzenes, such as 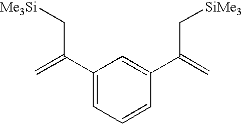
(where Me is methyl),
(iii) compounds having at least two vinylidene groups arranged to have conjugation with respect to each of two aromatic rings, e.g. bisdiphenylethylenes, such as

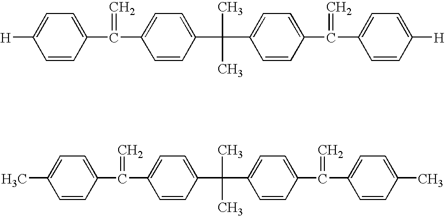

A description of suitable coupling agents is found in the following references; the coupling reaction may be carried out in a manner similar to that for the reactions described in these references: R. Faust, S. Hadjikyriacou, Macromolecules 2000, 33, 730-733; R. Faust, S. Hadjikyriacou, Macromolecules 1999, 32, 6393-6399; R. Faust, S. Hadjikyriacou, Polym. Bull. 1999, 43, 121-128; R. Faust, Y. Bae, Macromolecules 1997, 30, 198; R. Faust, Y. Bae, Macromolecules 1998, 31, 2480; R. Storey, Maggio, Polymer Preprints 1998, 39, 327-328; WO99/24480; U.S. Pat. No. 5,690,861, and U.S. Pat. No. 5,981,785.

The coupling generally takes place in the presence of a Lewis acid, suitable Lewis acids being those which can also be used to carry out the actual polymerization reaction. The solvents and temperatures suitable for carrying out the coupling reaction are moreover also the same as those used to carry out the actual polymerization reaction. The coupling may therefore advantageously be carried out as a reaction in the same vessel, following the polymerization reaction, in the same solvent, in the presence of the Lewis acid used for the polymerization.

Hydroxy-Terminated Isobutene Polymers

Isobutene polymers having terminal hydroxy groups may be obtained from isobutene polymers having a terminal double bond via hydroboration followed by oxidation. Among the suitable hydroboration agents are especially borane (BH₃) itself or diisoamylborane, or 9-borabicyclo[3.3.1]nonane (9-BBN). It is well known to the person skilled in the art that borane occurs mainly in the form of its dimer, diborane (B₂H₆). The term “borane” is intended to comprise the dimer and the higher oligomers of borane.

Borane is advantageously generated in situ via reaction of suitable precursors, in particular of alkali metal or alkaline earth metal salts of the BH₄ anion with boron trihalides. Use is generally made of sodium borohydride and boron trifluoride or its etherate, because these are readily obtainable substances with good storage properties. The hydroboration agent is therefore preferably a combination of sodium borohydride and boron trifluoride or boron trifluoride etherate.

The hydroboration is usually carried out in a solvent. Examples of suitable solvents for the hydroboration reaction are acyclic ethers, such as diethyl ether, methyl tert-butyl ether, dimethoxyethane, diethylene glycol dimethyl ether, triethylene glycol dimethyl ether, cyclic ethers, such as tetrahydrofuran or dioxane, or else hydrocarbons, such as hexane or toluene, or mixtures thereof.

The polyisobutenylboranes formed are not usually isolated. Treatment of the primary hydroboration products with an oxidant, in particular alkaline hydrogen peroxide, gives an alcohol which formally is the anti-Markownikow hydration product of the unsaturated isobutene polymer.

Crosslinking Agents Having Hydrosilyl Groups

This crosslinking agent is a compound having at least two, preferably at least three, SiH groups (hydrosilyl groups) in the molecule. Two hydrogen atoms bonded to a silicon atom count as two hydrosilyl groups. It is preferable to use a polysiloxane, which may, by way of example, have the following linear or cyclic structures: 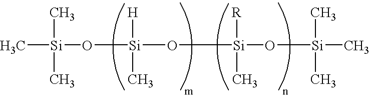
where m and n are whole numbers for which: 10≦(m+n)≦50, 2≦m, and 0≦n; and R is a C₂-C₂₀-hydrocarbon radical which may comprise one or more phenyl groups; 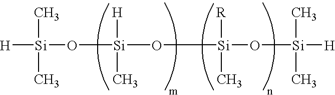
where m and n are whole numbers for which: 10≦(m+n)≦50, m≦0, and n≦0; and R is a C₂-C₂₀-hydrocarbon radical which may comprise one or more phenyl groups; 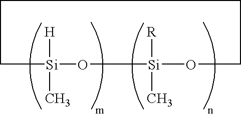
where m and n are whole numbers for which: 10≦(m+n)≦20, 2≦m≦20, and 0≦n≦18; and R is a C₂-C₂₀-hydrocarbon radical which may comprise one or more phenyl groups.

The crosslinking agent used may also comprise an organic compound having at least two hydrosilyl groups in the molecule, e.g. of the formula
QXₐ
where Q is a mono- to tetravalent organic radical having from 2 to 2000 carbon atoms, and X is a group which comprises at least one hydrosilyl group.

By way of example X is linear or cyclic polysiloxane radicals of the following formulae: 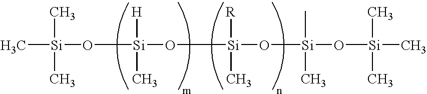
where m and n are whole numbers for which: 1≦(m+n)≦50, 1≦m, and n≦0; and R is a C₂-C₂₀-hydrocarbon radical which may comprise one or more phenyl groups; 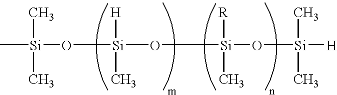
where m and n are whole numbers for which: 0≦(m+n)≦50, m≦0, and n≦0; and R is a C₂-C₂₀-hydrocarbon radical which may comprise one or more phenyl groups; 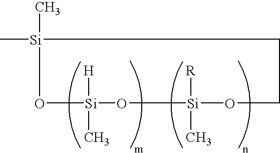
where m and n are whole numbers for which: 1≦(m+n)≦19, 1≦m≦19, and 0≦n≦18; and R is a C₂-C₂₀-hydrocarbon radical which may comprise one or more phenyl groups.

X may moreover be groups which comprise at least one hydrosilyl group and are not found among the polysiloxanes, e.g.:
—Si(H)ₙ(Alk)₃₋ₙ
where Alk=methyl, ethyl, propyl, butyl, cyclohexyl, or phenyl, and n=1-3;
—Si(CH₃)₂Si(CH₃)₂H,
—Si(CH₃)₂CH₂CH₂Si(CH₃)₂H,
—Si(CH₃)₂Si(CH₃)H₂,
—Si(CH₃)₂—C₆H₄—Si(CH₃)₂H,
—Si(CH₃)₂NHSi(CH₃)₂H,
—Si(CH₃)₂N[Si(CH₃)₂H]₂,
—Si(CH₃)₂OC(CH₃)═NSi(CH₃)₂H and
—Si(CH₃)₂NC(CH₃)═NSi(CH₃)₂H.

Specific examples of suitable crosslinking agents are dodecyloxytetra(methyl-hydrosiloxy)dodecane, dodecyloxytetra(dimethylsiloxy)tetra(methylhydrosiloxy)-dodecane, octyloxytetra(dimethylsiloxy)tetra(methylhydrosiloxy)octane, para-bis(dimethylsilyl)benzol, bis(dimethylsilyl)ethane, bis(dimethylsilyl)butane, 1,1,3,3-tetra-methyldisiloxane, 1,1,1,3,5,7,7,7-octamethyltetrasiloxane, 1,1,3,3-tetraethyldisiloxane, 1,1,1,3,5,7,7,7-octaethyltetrasiloxane, 1,1,3,3-tetraphenyldisiloxane, 1,1,1,3,5,7,7,7-octaphenyltetrasiloxane, 1,3,5-trimethylcyclotrisiloxane, 1,3,5,7-tetramethylcyclo-tetrasiloxane, 1,3,5,5,7,7-hexamethylcyclotetrasiloxane, 1,3,5,7,7-pentamethylcyclo-tetrasiloxane, 1,3,5,7-tetramethyl-5,7-diphenyltetrasiloxane, 1,3-dimethyl-5,5,7,7-tetra-phenyltetrasiloxane or reaction products thereof with di- or polyolefins having up to 2000 carbon atoms, with the proviso that the reaction products have at least two hydrosilyl groups.

The crosslinking process usually makes concomitant use of hydrosilylation catalyst. The catalyst used may be any desired catalyst, in particular those based on noble metal, preferably based on platinum. Among these are chloroplatinic acid, elemental platinum, platinum on a solid support, such as alumina, silica or activated carbon, platinum-vinylsiloxane complexes, such as Ptₙ(ViMe₂SiOSiMe₂Vi)ₙ and Pt[(MeViSiO)₄]ₘ, platinum-phosphine complexes, such as Pt(PPh₃)₄ and Pt(PBu₃)₄, platinum phosphite complexes, such as Pt[P(OPh)₃]₄ and Pt[P(OBu)₃]₄ (where Me in the formulae is methyl, Bu is butyl, Vi is vinyl, Ph is phenyl and n and m are whole numbers), platinum acetylacetonate. Other hydrosilylation catalysts are RhCl(PPh₃)₃, RhCl₃, Rh/Al₂O₃, RuCl₃, IrCl₃, FeCl₃, AlCl₃, PdCl₂, NiCl₂, and TiCl₄. The amount usually used of the catalyst is from 10⁻¹ to 10⁻⁸ mol, preferably from 10⁻² to 10⁻⁶ mol, based on one mole of olefinically unsaturated group in the isobutene polymer.

Crosslinking Agents Having Isocyanate Groups

In this embodiment, the crosslinking agent is an isocyanate of functionality two or higher, preferably selected from diisocyanates, the biuretes and cyanurates of diisocyanates, and also the adducts of diisocyanates onto polyols. Suitable diisocyanates generally have from 4 to 22 carbon atoms. The diisocyanates have usually been selected from aliphatic, cycloaliphatic, and aromatic diisocyanates, e.g. 1,4-diisocyanatobutane, 1,6-diisocyanatohexane, 1,6-diisocyanato-2,2,4-trimethylhexane, 1,6-diisocyanato-2,4,4-trimethylhexane, 1,2-, 1,3-, and 1,4-diisocyanatocyclohexane, 2,4- and 2,6-diisocyanato-1-methylcyclohexane, 4,4′-bis(isocyanatocyclohexyl)methane, isophorone diisocyanate (=1-isocyanato-3,3,5-trimethyl-5-isocyanatomethylcyclohexane), tolylene 2,4- and 2,6-diisocyanate, tetramethylene-p-xylylene diisocyanate (=1,4-bis(2-isocyanatoprop-2-yl)benzene), 4,4′-diisocyanatodiphenylmethane, preferably 1,6-diisocyanatohexane and isophorone diisocyanate, and mixtures thereof. Preferred compounds comprise the cyanurates and biuretes of aliphatic diisocyanates, in particular the cyanurates. Particularly preferred compounds are the isocyanurate and the biurete of isophorone diisocyanate and the isocyanurate and the biurete of 1,6-diisocyanatohexane. Examples of adducts of diisocyanates onto polyols are the adducts of the abovementioned diisocyanates onto glycerol, trimethylolethane, and trimethylolpropane, e.g. the adduct of tolylene diisocyanates onto trimethylolpropane, or the adducts of 1,6-diisocyanatohexane or isophorone diisocyanate onto trimethylolpropane and/or glycerol.

To accelerate the reaction between the isocyanate-reactive groups of the isobutene polymer and the isocyanate groups of the crosslinking agent, use may be made of known catalysts, e.g. dibutyltin dilaurate, tin-(II)-octoate, 1,4-diazabicyclo[2.2.2]octane, or amines, such as triethylamine. The amount typically used of these is from 10⁻⁵ to 10⁻² g, based on the weight of the crosslinking agent.

The density of crosslinking may be controlled via variation of the functionality of the polyisocyanate, or of the molar ratio of the polyisocyanate with respect to the hydroxy-terminated isobutene polymer, or via concomitant use of monofunctional compounds reactive toward isocyanate groups, e.g. monohydric alcohols, for example ethylhexanol or propylheptanol.

Reinforcing Polymer

The second phase of the inventive molding composition is formed by a polymer which is obtainable via free-radical polymerization of (meth)acrylic monomers or of vinylaromatic monomers. Examples of suitable monomers are styrene, ring-alkylated styrenes preferably having C₁-C₄-alkyl radicals, e.g. α-methylstyrene, p-methylstyrene, acrylonitrile, methacrylonitrile, acrylamide or methacrylamide, and alkyl (meth)acrylates having from 1 to 4 carbon atoms in the alkyl radical, for example particularly methyl methacrylate. Preference is given to the use of monomers and monomer mixtures which give a (co)polymer with a glass transition temperature above +20° C. and preferably above +50° C.

In order to prepare functional polymers with particular properties, the monomers of the second phase can also comprise ionic monomers. Examples of those which can be used are monomers having an ionic pendent groups, e.g. (meth)acrylic acid, fumaric acid, maleic acid, itaconic acid, or preferably vinylsulfonic acid or styrenesulfonic acid, in which the acidic groups can have been neutralized completely or to some extent, and which can by way of example take the form of alkali metal salts, such as the sodium salt; or monomers having cationic pendent groups, e.g. (2-(acryloyloxy)ethyl)trimethylammonium chloride.

The reinforcing polymer may comprise not only (meth)acrylic monomers or vinylaromatic monomers but also other monomers. The (meth)acrylic monomers or vinylaromatic monomers generally make up at least 20% by weight, preferably at least 50% by weight, in particular at least 70% by weight, of the constituent monomers, e.g. from 20 to 40% by weight for materials whose properties are mainly similar to those of the polyisobutenes, but whose mechanical properties have been improved by the presence of the reinforcing polymer, or from 70 to 90% by weight for impact-modified materials. The monomer used particularly preferably comprises mixtures which comprise at least 50% by weight of styrene or methyl methacrylate.

Concomitant use is advantageously made of crosslinking monomers. Among these are in particular compounds which have at least two unconjugated, ethylenically unsaturated double bonds, e.g. the diesters of dihydric alcohols with αβ-monoethylenically unsaturated C₃-C₁₀ monocarboxylic acids. Examples of compounds of this type are alkylene glycol diacrylates and alkylene glycol dimethacrylates, e.g. ethylene glycol diacrylate, 1,3-butylene glycol diacrylate, 1,4-butylene glycol diacrylate, propylene glycol diacrylate, divinylbenzene, vinyl methacrylate, vinyl acrylate, allyl methacrylate, allyl acrylate, diallyl maleate, diallyl fumarate, methylenebisacrylamide, cyclopentadienyl acrylate, tricyclodecenyl (meth)acrylate, N,N′-divinylimidazolin-2-one, or triallyl cyanurate. The amount usually used of the crosslinking monomers is from 0.1 to 30% by weight, preferably from 1 to 20% by weight, in particular from 2 to 15% by weight, based on the total amount of the monomers constituting the reinforcing polymer.

To prepare an inventive molding composition, the monomers constituting the reinforcing polymer are polymerized by a free-radical route, either in the presence of a previously prepared network composed of a crosslinked isobutene polymer or with simultaneous crosslinking of the isobutene polymer.

The polymerization is initiated by means of an initiator which forms free radicals or, as an alternative, via high-energy radiation, such as UV radiation or electron beams. The amount of the initiator usually used is from 0.1 to 2% by weight, based on the total amount of the monomers of the reinforcing polymer. The person skilled in the art is aware of suitable initiators from the class of the peroxide compounds, azo compounds, or azo peroxide compounds, and these are commercially available.

Examples which may be mentioned as suitable initiators are di-tert-butyloxy pivalate, didecanoyl peroxide, dilauroyl peroxide, diacetyl peroxide, di-tert-butyl peroctoate, dibenzoyl peroxide, tert-butyl peracetate, tert-butyl peroxyisopropyl carbonate, tert-butyl perbenzoate, di-tert-butyl peroxide, 1,1-bis(tert-butylperoxy)-3,3,5-trimethylcyclohexane, 2,5-dimethyl-2,5-bis(benzoylperoxy)hexane, 1,4-di(tert-butylperoxycarbonyl)cyclohexane, 1,1-bis(tert-butylperoxy)cyclohexane, di-tert-butyl diperoxyazelate, or di-tert-butyl peroxycarbonate. Among these, preference is given to dilauroyl peroxide, dibenzoyl peroxide, tert-butyl perbenzoate, and tert-butyl peroxy-isopropyl carbonate.

The polymerization usually takes place at an elevated temperature, a suitable temperature range being from 40 to 180° C., preferably from 60 to 120° C. The temperature may advantageously also be increased in stages. If the polymerization is initiated via high-energy radiation, lower temperatures are also suitable, e.g. ambient temperature.

The polymerization usually takes the form of a bulk polymerization. Concomitant use may be made of solvents, if appropriate. Suitable materials here are saturated or unsaturated aliphatic hydrocarbons, such as hexane, pentane, isopentane, cyclohexane, methylcyclohexane, diisobutene, triisobutene, tetraisobutene, pentaisobutene, hexaisobutene, or mixtures thereof, aromatic hydrocarbons, such as benzene, toluene, xylene, or mixtures thereof. The polymerization may also be carried out in the presence of a plasticizer or of a plasticizer mixture, e.g. the phthalates and adipates of aliphatic or aromatic alcohols, e.g. di(2-ethylhexyl)adipate, di(2-ethylhexyl) phthalate, diisononyl adipate, or diisononyl phthalate. If the functional groups of the isobutene polymer and of the crosslinking agent of the selected crosslinking system are not sensitive to water, the polymerization may also take the form of an aqueous suspension polymerization with simultaneous crosslinking.

If the polymerization is carried out in the presence of the previously crosslinked isobutene polymer, the rubbery isobutene network may either be present in the desired shape of the finished molding or in comminuted form, e.g. in the form of pellets. The rubbery isobutene network is permitted to swell or equilibrate to a sufficient extent with the monomers which form the reinforcing polymer of the second phase. To improve swelling, it can be advantageous to make concomitant use of one of the solvents mentioned. If desired, auxiliaries may be incorporated during this stage of the preparation process. After the equilibration or swelling, the polymerization is initiated in a suitable manner, e.g. by increasing the temperature.

The use of the previously crosslinked isobutene polymer in comminuted, e.g. pelletized, form is advantageous particularly when the reinforcing polymer is thermoplastic, i.e. has very little or no crosslinking. In this case, the polyisobutene network gives impact-modification of the thermoplastic.

An alternative procedure mixes the isobutene polymer, the crosslinking agent, where required, crosslinking catalysts, and auxiliaries, and the monomers which form the structure of the reinforcing polymer, and simultaneously or in succession initiates the reaction between the isobutene polymer and the crosslinking agent and the free-radical polymerization of the monomers. The mixture of the components may suitably be charged to a casting mold and fully cured, e.g. via temperature increase. The sequential initiation of the reaction between the isobutene polymer and the crosslinking agent and the free-radical polymerization of the monomers may be achieved via a staged temperature increase, for example.

The inventive molding compositions may also comprise conventional auxiliaries, such as fillers, diluents, or stabilizers.

In order to improve the compatibility of the first phase with the second phase, concomitant use of polymeric compatibilizers can be desirable. Especially suitable materials of this type are polymers having polyether units, having polyester units, or having polyamide units. Examples of suitable polymeric compatibilizers are polyethylene glycols. The polymeric compatibilizers are preferably crosslinked materials. The polymeric compatibilizer can thus form a network penetrating the first phase. The crosslinking of the polymeric compatibilizer and of the isobutene polymer can take place simultaneously if the polymeric compatibilizer and the isobutene polymer have suitable functional groups which react with the same crosslinking agent. By way of example, it is therefore possible to mix a hydroxy-terminated polyisobutene and a polyethylene glycol, and jointly crosslink these using an isocyanate whose functionality is two or higher.

Examples of suitable fillers are silica, colloidal silica, calcium carbonate, carbon black, titanium dioxide, mica, and the like.

Examples of suitable diluents are polybutene, liquid polybutadiene, hydrogenated polybutadiene, paraffin oil, naphthenates, atactic polypropylene, dialkyl phthalates, reactive diluents, e.g. alcohols, and oligoisobutene.

Examples of suitable stabilizers are 2-benzothiazolyl sulfide, benzothiazole, thiazole, dimethyl acetylenedicarboxylate, diethyl acetylenedicarboxylate, BHT, butylhydroxyanisole, vitamin E.

The inventive molding composition can be produced in any desired form, e.g. in the form of a film or membrane, or in the form of a flowable solid, examples being beads, pellets, cylinders, powders, and the like.

The excellent low permeability of the molding composition to gas and water vapor and its mechanical stability, inter alia with respect to cracking and penetration by sharp or blunt objects makes it particularly suitable for producing materials or moldings for the roofing of buildings. To this end, it may be provided in the form of film webs or sheets. In addition the molding composition can be used, inter alia, for sealing chimneys; in the form of impact-modified polymethyl methacrylate for producing panes for automotive construction or hothouses and greenhouses or conservatories; or in the form of impact-modified polystyrene for producing moldings via extrusion, thermoforming, blow molding, or injection molding.

Moldings composed of the inventive molding composition can easily be bonded to one another, and the resultant permeability to gas and water vapor and the resultant mechanical properties of the joint are substantially the same as those of the molding composition, by

(i) preparing a curable mixture composed of an isobutene polymer defined above and of a crosslinking agent defined above,

(ii) bringing the mixture into contact with those surfaces of the moldings to be bonded, and

(iii) permitting the mixture to cure fully.

The curable mixture preferably comprises a solvent and/or reactive diluent, in order to adjust to a suitable viscosity for relatively easy application at a very small layer thickness. Aliphatic hydrocarbons, such as hexane, pentane, isopentane, cyclohexane or methylcyclohexane are suitable for this purpose, as are aromatic hydrocarbons, such as benzene, toluene, or xylene, and also halogenated hydrocarbons, such as dichloromethane or dichloroethane, ethers, such as tetrahydrofuran and diethylether, and other diluents, e.g. low-molecular-weight isobutene oligomers, e.g. with a number-average molecular weight from 112 to 1000, or mixtures thereof. Prior to the application process, the mixture may be permitted to overgo preliminary reaction, but not as far as complete and full curing.

For the adhesive bonding process, the moldings, e.g. webs, may be placed with their edges together or at a distance from one another, and the curable mixture may be applied to the surfaces adjoining one another or adjacent to one another, and/or to the gap between the surfaces. The curable mixture may also be applied to that surface to be adhesive-bonded on one molding, e.g. to the edge region of a film web, and a second molding may then be brought into contact with the treated surface, e.g. a second film web may be overlapped at the edges. In most cases, full curing takes place sufficiently rapidly even at ambient temperature, and an elevated temperature can be used if desired.

The invention is further illustrated by the attached figures and the examples below (the abbreviation PIB being used occasionally below for polyisobutene).

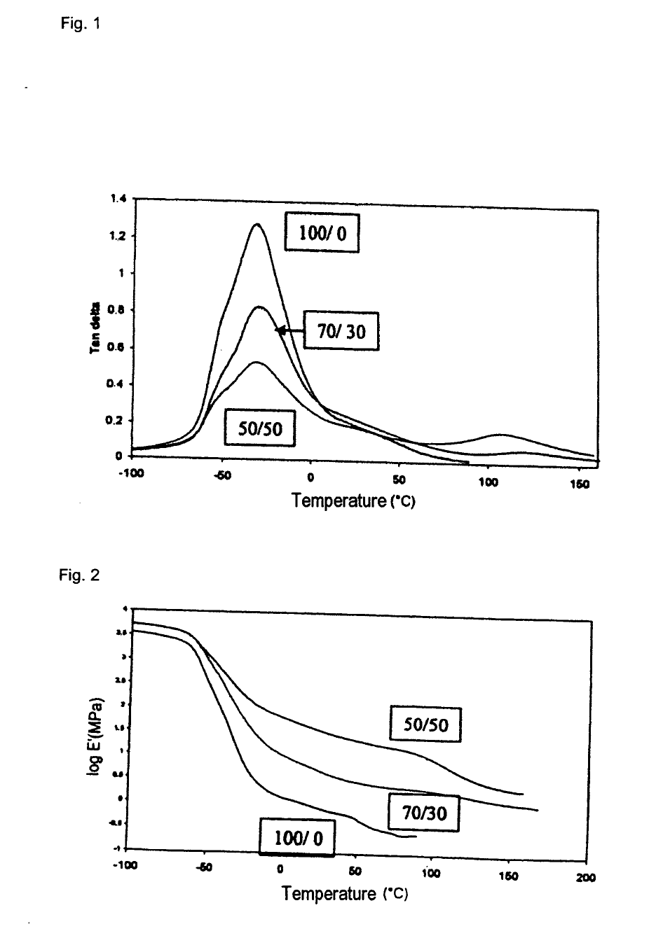

FIG. 1 shows the loss factor (tan δ) as a function of temperature for interpenetrating networks with various contents by weight of PIB/polystyrene phase.

FIG. 2 shows the storage modulus as a function of temperature for interpenetrating networks with various contents by weight of PIB/polystyrene phase.

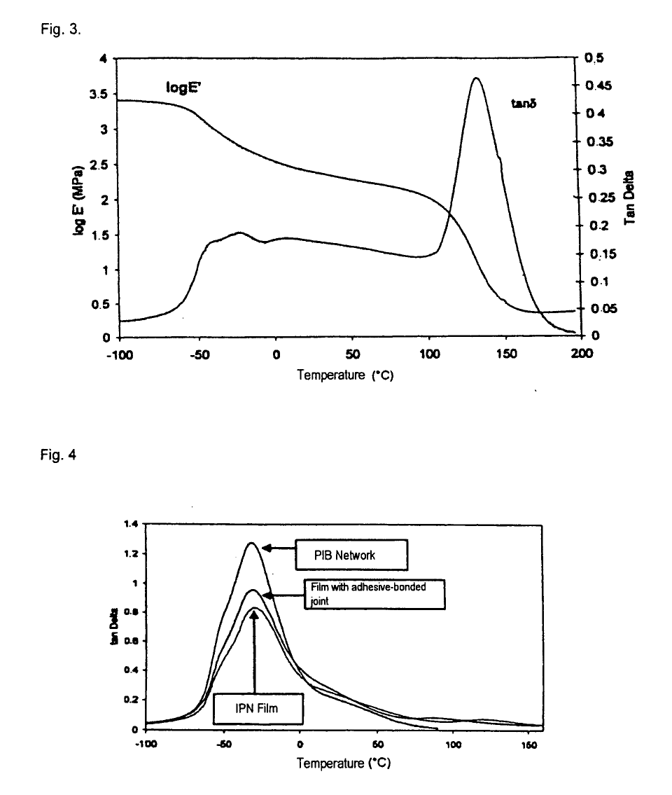

FIG. 3 shows the loss factor (tan δ) and the storage modulus as a function of temperature for a sequential interpenetrating network with PIB/polystyrene phase content by weight of 70/30.

FIG. 4 shows the loss factor (tan δ) as a function of temperature for a one-piece film composed on an interpenetrating PIB/polystyrene network, for a film with adhesive joint, and for a single-piece PIB network.

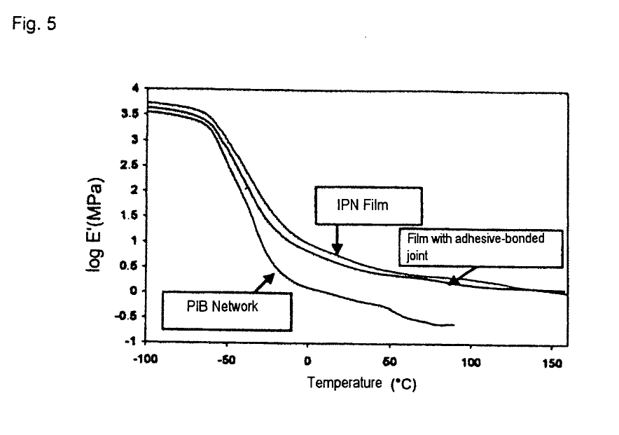

FIG. 5 shows the storage modulus as a function of temperature for a one-piece film composed on an interpenetrating PIB/polystyrene network, for a film with adhesive joint, and for a single-piece PIB network.

### EXAMPLE 1

1 g of α,ω-dihydroxypolyisobutene (Mn 4200) was dissolved in 1.1 ml of styrene and 120 μl of divinylbenzene (11% by weight, based on styrene) under an inert atmosphere of argon. The mixture was treated with 5 mg of benzoyl peroxide (0.5% by weight, based on styrene), 110 mg of Desmodur® N3300 (polyisocyanate from Bayer with an average of 21.8 g of isocyanate groups/100 g of product; 11% by weight, based on polyisobutene), and 28 μl of dibutyltin dilaurate, and these materials were thoroughly mixed. The mixture was transferred into a casting mold which was composed of two glass sheets held apart by a Teflon gasket of thickness 0.5 mm. The casting mold was held together by clamps and placed in a temperature-controlled oven. The temperature was kept for 6 h at 60° C., then 2 h at 80° C., and finally 2 h at 100° C. The casting mold was removed from the oven and allowed to cool, and the specimen was demolded.

This gave a translucent, flexible film with a glass transition temperature (Tg) of −71° C. and, respectively, +80° C. as determined by DSC (the Tg of pure polystyrene with 11% by weight of divinylbenzene being +108° C. for comparison, while the Tg of α,ω-dihydroxypolyisobutene crosslinked in the absence of styrene is −67° C.). The ratio by weight of PIB/polystyrene phase in the resultant interpenetrating network is about 50/50.

### EXAMPLE 2

Example 1 was repeated, but the selection of the amounts was such as to give an interpenetrating network a content by weight of PIB/polystyrene phase of 30/70. This gave a translucent flexible film with glass transition temperatures of −65° C. and +90° C.

Interpenetrating networks with PIB/polystyrene phase ratios by weight of from 90/10 to 10/90 could be prepared in the same way.

The mechanical properties of various interpenetrating networks were determined via dynamic mechanical analysis. The results are given in the table below and in FIGS. 1 and 2. The storage modulus (E′) and the loss modulus (E″) characterize the amounts of energy stored via elastic behavior and, respectively, convert it into heat via molecular friction processes. The material is characterized by the loss factor tan δ(=E″/E′). As tan δ increases, the material becomes more effective in damping vibrations. The storage modulus is seen to increase as polystyrene content rises.

### EXAMPLE 3

2 g of α,ω-dihydroxypolyisobutene (Mn 4200), 220 mg of Desmodur® N3300, and 56 μl of dibutyltin dilaurate were mixed and crosslinking was then carried out for 6 h at 60° C. in a Teflon casting mold. The crosslinking and demolding processes gave an elastomeric film. This film was immersed for 12 h in a solution comprising styrene, divinylbenzene (11% by weight, based on styrene), and benzoyl peroxide (0.5% by weight, based on styrene). The elastomeric film was replaced in the casting mold and cured in an oven for 2 h at 80° C. and then 2 h at 100° C. The casting mold was removed from the oven and allowed to cool. This gave a translucent flexible film comprising about 70% by weight of polyisobutene.

The results of dynamic mechanical analysis are shown in FIG. 3.

### EXAMPLE 4

A solution was prepared by mixing 2 g of α,ω-dihydroxypolyisobutene (Mn 4200), 220 mg of Desmodur® N3300, and 56 μl of dibutyltin dilaurate, and dissolving the mixture in 1.1 g of dichloromethane.

Strips of 1×2 cm were cut from films prepared as in Example 2. Two strips were placed on a Teflon substrate with the narrow sides adjacent to one another and separated by about 0.3 mm. The solution prepared above was distributed within the gap between the strips and over a width of in each case 0.3 cm on the adjacent surface of the strips. The arrangement was left for 12 h at room temperature. The thickness of the strips was greater by 0.22 mm at the sites of application of the solution.

The results of dynamic mechanical analysis are shown in FIGS. 4 and 5. It can be seen that the adhesive-bonded specimen and the one-piece specimen have substantially identical behavior. In a further experiment, the adhesive-bonded specimen was placed in boiling water for two days and then extracted with boiling dichloromethane in a Soxhlet extractor. No impairment of mechanical strength or quality of the adhesive bond was observed.

### EXAMPLE 5

1 g of α,ω-dihydroxypolyisobutene (Mn 4200) was dissolved in 1.1 ml of styrene under an inert atmosphere of argon. The mixture was treated with 5 mg of benzoyl peroxide (0.5% by weight, based on styrene), 110 mg of Desmodur® N3300, and 28 μl of dibutyltin dilaurate, and these materials were thoroughly mixed. The mixture was transferred into a casting mold which was composed of two glass sheets held apart by a Teflon gasket of thickness 0.5 mm. The casting mold was held together by clamps and placed in a temperature-controlled oven. The temperature was kept for 6 h at 60° C., then 2 h at 80° C., and finally 2 h at 100° C. The casting mold was removed from the oven and allowed to cool, and the specimen was demolded. This gave a white, flexible film.

### EXAMPLE 6

Interpenetrating networks with various PIB/polystyrene phase ratios by weight were prepared in a manner similar to that of Example 5.

The results of dynamic mechanical analysis are given in the table below.

| | Extractable | | | |
|---|---|---|---|---|
| PIB/PS | fractions | | | Storage modulus |
| ratio by weight | [% by weight]⁽¹⁾ | Tg₁⁽²⁾ | Tg₂⁽²⁾ | E′ (MPa)⁽³⁾ |
| 100/0 | 0 | −31 | — | 0.8 |
| 50/50 | 22 | −28 | +122 | 2.1 |
| 40/60 | 26 | −21 | +127 | 12.2 |
| 20/80 | 44 | −18 | +123 | 50.8 |

⁽¹⁾48 hours of Soxhlet extraction in dichloromethane
⁽²⁾Tg was determined via dynamic mechanical analysis at the maximum of tanδ.
⁽³⁾at 25° C.

### EXAMPLE 7

A mixture was prepared as described in Example 1 and charged to a syringe. The piston was depressed to extrude a coherent viscous strand with a diameter of about 0.8 mm, which was conducted through a heating zone in which the temperature varied from ambient temperature to 120° C. and back to ambient temperature between entry and exit of the strand. Passage through the heating zone within about 5 min gave a translucent, flexible fibrous material.

### EXAMPLE 8

1 g of α,ω-dihydroxypolyisobutene (Mn 4200) was dissolved in 4 g of methyl methacrylate (MMA) and 120 μl of ethylene glycol dimethacrylate (3% by weight, based on MMA) under an inert atmosphere of argon. The mixture was treated with 20 mg of benzoyl peroxide (0.5% by weight, based on MMA), 110 mg of Desmodur® N3300 (polyisocyanate from Bayer with an average of 21.8 g of isocyanate groups/100 g of product; 11% by weight, based on polyisobutene), and 28 μl of dibutyltin dilaurate, and these materials were thoroughly mixed. The mixture was transferred into a casting mold which was composed of two glass sheets held apart by a Teflon gasket of thickness 0.5 mm. The casting mold was held together by clamps and placed in a temperature-controlled oven. The temperature was kept for 6 h at 60° C., then 1 h at 80° C. The casting mold was removed from the oven and allowed to cool, and the specimen was demolded.

Interpenetrating networks with various PIB/PMMA phase ratios by weight were prepared in a similar manner.

The results of dynamic mechanical analysis are given in the table below.

| PIB/PMMA | | | Storage modulus | |
|---|---|---|---|---|
| ratio by weight | Tg₁⁽¹⁾ | Tg₂⁽¹⁾ | E′ (MPa)⁽²⁾ | Tanδ⁽³⁾ |
| 100/0 | −29.6 | | 0.7 | 0.19 |
| 70/30 | −27.7 | 156 | 3.9 | 0.22 |
| 60/40 | −27.1 | 156 | 3.9 | 0.21 |
| 50/50 | −27.9 | 154 | 16.3 | 0.18 |
| 40/60 | −31.1 | 150 | 51.3 | 0.14 |
| 30/70 | −32.4 | 154 | 117.4 | 0.11 |
| 20/80 | −29.6 | 149 | 201.0 | 0.11 |
| 10/90 | −44.0 | 101 | 644.3 | 0.11 |
| 0/100 | | 125 | 2383.0 | 0.07 |

⁽¹⁾Tg was determined via dynamic mechanical analysis at the maximum of tanδ.
⁽²⁾at 25° C.
⁽³⁾at 25° C.

### EXAMPLE 9

2 g of α,ω-dihydroxypolyisobutene (Mn 4200), 220 mg of Desmodur® N3300, and 56 μl of dibutyltin dilaurate were mixed, and crosslinking was then carried out for 6 h at 60° C. in a Teflon casting mold. The crosslinking and demolding process gave an elastomeric film. This film was immersed for 12 h in a solution which comprised MMA, ethylene glycol dimethacrylate (3% by weight, based on MMA), and benzoyl peroxide (0.5% by weight, based on MMA). The elastomeric film was replaced in the casting mold and cured in an oven for 2 h at 80° C. and then 2 h at 100° C. The casting mold was removed from the oven and allowed to cool. This gave a translucent flexible film comprising about 30% by weight of PMMA and 70% by weight of polyisobutene.

In dynamic mechanical analysis, three transitions were observed in the tan δ curves, at −22° C., +11° C., and +135° C. The transitions at −22° C. and +135° C. can be attributed to the movements of the PIB molecular chains and PMMA molecular chains. The transition at +11° C. appears to indicate the appearance of a new PIB-rich phase.

### EXAMPLE 10

0.4 g of α,ω-dihydroxypolyisobutene (Mn 4200) was dissolved in 1.6 ml of methyl methacrylate (MMA) under an inert atmosphere of argon. The mixture was treated with 8 mg of benzoyl peroxide (0.5% by weight, based on MMA), 37 mg of Desmodur® N3300, and 1.1 μl of dibutyltin dilaurate, and 300 μl of toluene and these materials were thoroughly mixed. The mixture was transferred into a casting mold which was composed of two glass sheets held apart by a Teflon gasket of thickness 0.5 mm. The casting mold was held together by clamps and placed in a temperature-controlled oven. The temperature was kept for 1 h at 60° C., then 1 h at 80° C. The casting mold was removed from the oven and allowed to cool, and the specimen was demolded. This gave a translucent flexible film.

1. A molding composition, comprising a mixture of interpenetrating polymers with a first phase of a crosslinked isobutene polymer and with a second phase of a reinforcing polymer which comprises (meth)acrylic and/or vinylaromatic units, where the first phase comprises the reaction product of an isobutene polymer with an average of at least 1.4 functional groups in the molecule and of a crosslinking agent with an average of at least two functional groups in the molecule, the functionality of these being complementary to that of the functional groups of the isobutene polymer.

2. The molding composition according to claim 1, wherein the ratio by weight of the first phase to the second phase is from 5:95 to 80:20.

3. The molding composition according to claim 1, wherein the isobutene polymer comprises at least 80% by weight of isobutene units.

4. The molding composition according to claim 1, wherein the functional groups of the isobutene polymer have been arranged exclusively at the ends of the isobutene polymer molecule.

5. The molding composition according to claim 1, wherein the isobutene polymer has a number-average molecular weight of from 500 to 50 000 prior to the crosslinking process.

6. The molding composition according to claim 1, wherein the crosslinking agent has an average of at least 2.5 functional groups.

7. The molding composition according to claim 1, wherein the functional groups of the isobutene polymer and of the crosslinking agent have been selected in pairs from hydroxy/isocyanate groups or olefinically unsaturated groups/hydrosilyl groups.

8. The molding composition according to claim 1, wherein the reinforcing polymer comprises styrene units and/or methyl methacrylate units.

9. The molding composition according to claim 1, wherein the reinforcing polymer comprises units of a crosslinking monomer.

10. The molding composition according to claim 8, wherein a ratio by weight of the first phase to the second phase is from 5:95 to 25:75, for use as impact-modified polystyrene or polymethyl methacrylate.

11. A process for preparing a molding composition according to claim 1, comprising:
(i) polymerizing the monomers which form the structure of the reinforcing polymer by a free-radical route in the presence of the first phase; or
(ii) mixing the isobutene polymer, the crosslinking agent, and the monomers which form the structure of the reinforcing polymer, wherein the reaction between the isobutene polymer and the crosslinking agent and the free-radical polymerization of the monomers are initiated simultaneously or in succession.

12. (canceled)

13. A process for the bonding of at least two moldings composed of a molding composition according to claim 1, comprising:
(i) preparing a curable mixture composed of an isobutene polymer defined in claim 1 and of a crosslinking agent defined in claim 1;
(ii) bringing the mixture into contact with those surfaces of the moldings that are to be bonded; and
(iii) permitting the mixture to cure fully.

14. A material or molding for the roofing of buildings comprising the molding composition of claim 1.
